(19) United States
(12) Patent Application Publication
(10) Pub. No.: US 2010/0180784 A1
(43) Pub. Date: Jul. 22, 2010

(54) RECORDING APPARATUS

(75) Inventor: Satoru Shiohara, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/620,676

(22) Filed: Nov. 18, 2009

(30) Foreign Application Priority Data
Dec. 10, 2008 (JP) 2008-314477

(51) Int. Cl. B41F 23/00

(52) U.S. Cl. 101/424.1

(57) ABSTRACT

A recording apparatus includes: a recording unit that performs a recording operation on a recording medium; a transport unit that transports the recording medium; and a drying unit that promotes drying of the recording medium by ejecting gas to the recording medium. The drying unit includes a main passage through which the gas flows on a surface of the recording medium along the transport direction of the recording medium, and a sub-passage that merges with the main passage and extends in a direction crossing the surface of the recording medium when merging with the main passage.

### BACKGROUND

1. Technical Field

The present invention relates to a recording apparatus such as a facsimile machine, a printer, etc., and more particularly to a recording apparatus including a drying unit that promotes a drying operation of a recording medium.

2. Related Art

As disclosed in JP-B-7-121580, dryers for drying ink on printed mediums have been conventionally suggested. In the drying unit described in JP-B-7-121580, heated air flows in parallel to an ink attached surface of the medium when the medium to which ink is attached proceeds along a medium path and then is guided to a heating element again to be re-circulated.

Meanwhile, JP-A-2002-292841 discloses a printer including a drying unit that dries ink attached to a paper sheet by ejecting hot air almost perpendicular to the paper sheet.

However, since in the drying unit disclosed in JP-B-7-121580, heated air flows in parallel to the ink attached surface of the medium, the efficiency of heat transfer to the medium decreases and the heated air needs to be blown over a wide range in order to sufficiently promote the drying operation, making the size of the drying unit large. Further, since in the printer described in JP-A-2002-292841, hot air is ejected almost perpendicular to a paper sheet, the hot air stays on the paper sheet for a short period of time, also decreasing the efficiency of heat transfer to the paper sheet and making the size of the printer large in order to dry the paper sheet sufficiently.

### SUMMARY

An advantage of some aspects of the invention is that it provides a recording apparatus that designed to provide an additional improvement to the efficiency of heat transfer to a paper sheet, thereby ensuring an efficient drying operation without making the size of the apparatus large.

According to the first aspect of the invention, there is provided a recording apparatus comprising: a recording unit that performs a recording operation on a recording medium; a transport unit that transports the recording medium; and a drying unit that promotes drying of the recording medium by ejecting gas to the recording medium, wherein the drying unit includes a main passage through which the gas flows on a surface of the recording medium along the transport direction of the recording medium, and a sub-passage that merges with the main passage and extends in a direction crossing the surface of the recording medium when merging with the main passage.

According to the first aspect of the invention, the recording apparatus includes a drying unit that promotes drying of the recording medium by ejecting gas to the recording medium, and since the drying unit includes a main passage for the gas flowing along the recording medium transport direction on a surface of the recording medium and a sub-passage that extends in a direction crossing a surface of the recording medium and merges with the main passage, the gas can comes into sufficient contact with the recording medium, thereby increasing the efficiency of heat transfer to the recording medium.

Further, since turbulent flows are formed when the sub-passage merges with the main passage, the drying of the recording medium can be promoted further by the turbulent flows. In addition, since the sub-passage extends in a direction crossing a surface of the recording medium and merges with the main passage, a pressing effect (floating preventing effect) of the recording medium can be obtained.

According to the second aspect of the invention, the sub-passage extends perpendicular to the surface of the recording medium when merging with the main passage.

According to the second aspect of the invention, the sub-passage extends perpendicular to a surface of the recording medium when it merges with the main passage, a remarkable pressing effect of the recording medium can be secured, thereby preventing the lowering of the recording quality that accompanies the floating of the recording medium. In particular, even if turbulent flows are formed when the sub-passage merges with the main passage, an end of the recording medium can be prevented from being floated by the turbulent flows.

According to the third aspect of the invention, the sub-passage is a serpentine passage that extends in a serpentine shape along the transport direction of the recording medium while branching out from the main passage and merges with the main passage at a plurality of points.

According to the third aspect of the invention, since the sub-passage is branched out from the main passage, the cost of the unit can be lowered without additionally providing a sub-passage forming unit, and since the sub-passage merges with the main passage at a plurality of points, the efficiency of heat transfer to the recording medium can be enhanced and the pressing effect (floating prevention effect) of the recording medium can be secured further.

According to the fourth aspect of the invention, the drying unit includes an exterior air intake passage that is formed using a case forming the serpentine passage, and the introduced exterior air is heated using the heat transferred from the case and is introduced into the drying unit.

According to the fourth embodiment of the invention, since the exterior air introduced into the drying unit is heated using heat transfer from a case (i.e. the sub-passage) forming a serpentine passage, energy can be saved by efficiently using the heat of the sub-passage.

### BRIEF DESCRIPTION OF THE DRAWINGS

The invention will be described with reference to the accompanying drawings, wherein like numbers reference like elements.

FIG. 1A is a side view illustrating main portions of a printer according to the first embodiment of the invention.

FIG. 1B is a plan view of FIG. 1A.

FIG. 2 is a cross-sectional view of a drying unit according to the first embodiment of the invention.

FIG. 3 is a cross-sectional view of a drying unit according to the second embodiment of the invention.

FIG. 4 is a cross-sectional view of a drying unit according to the third embodiment of the invention.

FIG. 5 is a cross-sectional view of a drying unit according to the fourth embodiment of the invention.

### DESCRIPTION OF EXEMPLARY EMBODIMENTS

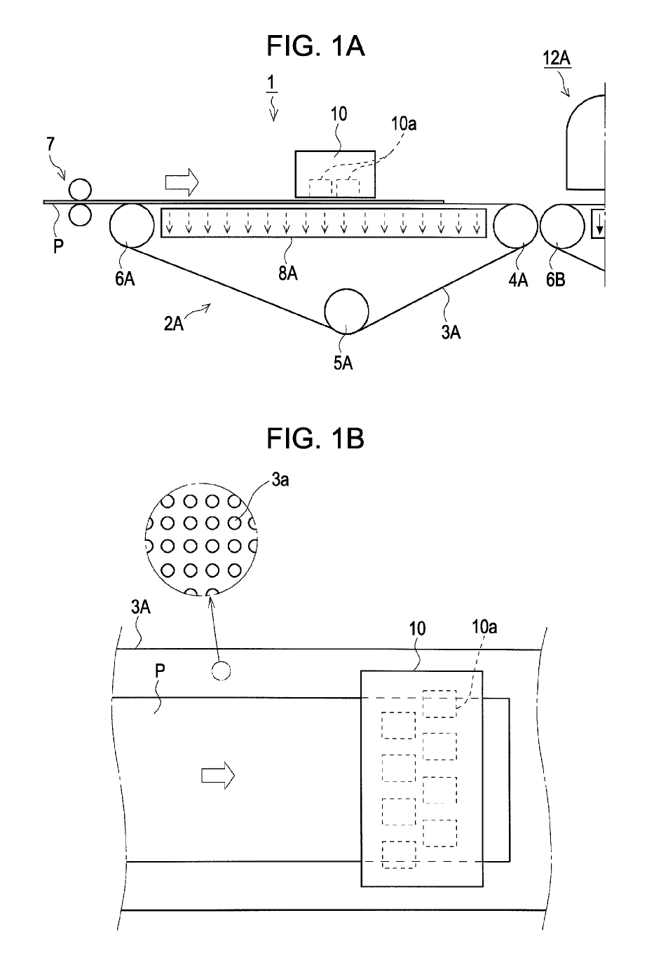

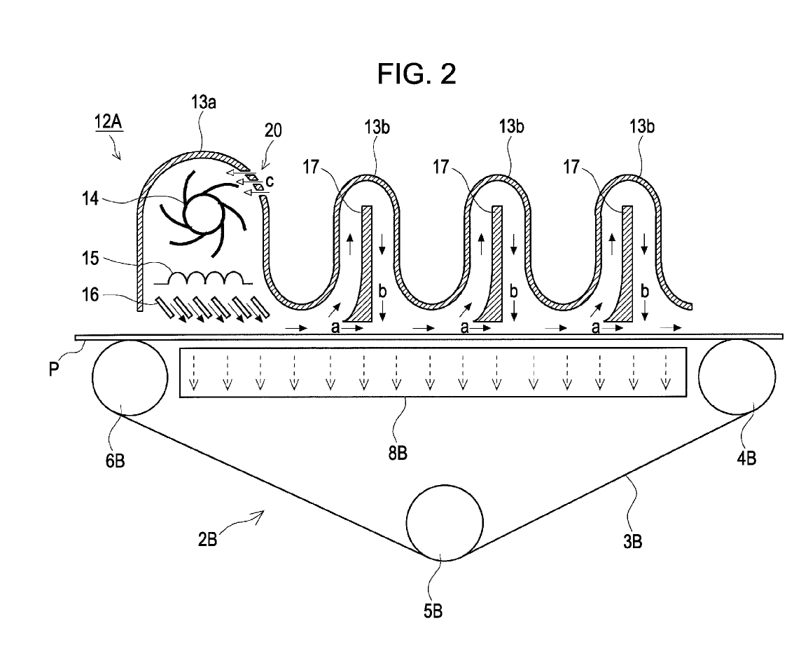

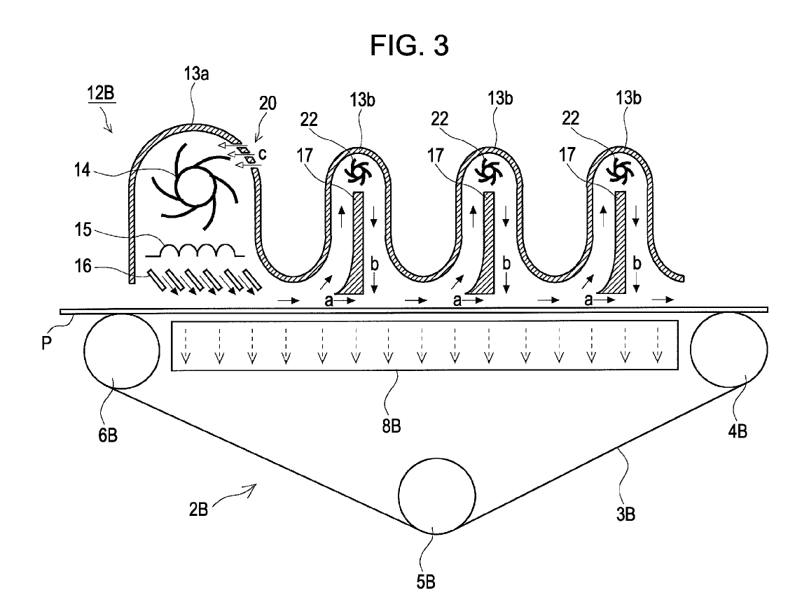

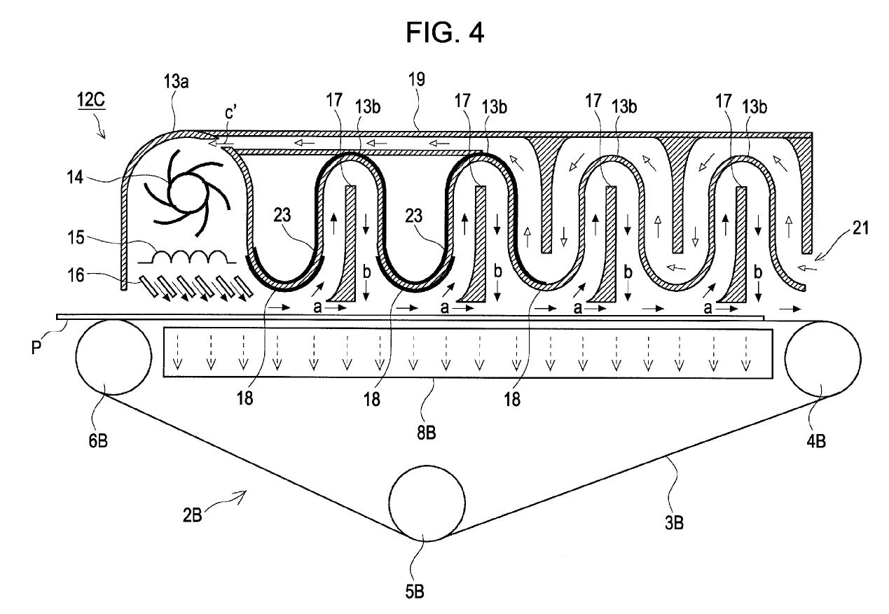

Hereinafter, the exemplary embodiments of the invention will be described in detail with reference to the accompanying drawings. FIG. 1A is a side view illustrating main portions of an ink jet printer 1 (hereinafter, referred to as ‘printer’) as a recording apparatus according to the first embodiment of the invention. FIG. 1B is a plan view of FIG. 1A. FIG. 2 is a cross-sectional view of a drying unit 12A according to the first embodiment of the invention. FIG. 3 is a cross-sectional view of a drying unit 12B according to the second embodiment of the invention. FIG. 4 is a cross-sectional view of a drying unit 12C according to the third embodiment of the invention.

For convenience, the transportation direction (the left-to-right direction in FIGS. 1 to 4) of a recording paper sheet P is referred to as ‘a paper sheet transportation direction’ and the direction (the upper-to-lower direction in FIG. 1B) perpendicular to the paper sheet transportation direction is referred to as ‘the paper sheet width direction’.

### First Embodiment

Hereinafter, the first embodiment of the invention will be described with reference to FIGS. 1 and 2.

The printer 1 according to the embodiment of the invention is a high through-put ink jet printer of a line head type that includes an ink jet type recording head (recording unit) 10 having a length covering the width of a paper sheet and performs a recording operation by ejecting ink from a recording head 10 while moving the recording paper sheet P as an example of the recording medium in the paper sheet transport direction without reciprocating the ink ejection head in the widthwise direction of the paper sheet.

In more detail, the printer 1 has gate rollers 7 on the upstream side of the transport unit 2, and the recording paper sheet P is supplied to the transport unit 2 on a downstream side (the right direction in FIG. 1B) by the gate roller 7, after skew is removed before the recording paper sheet P is supplied to the transport unit 2.

A transport belt 3A forming a transport surface for transporting the recording paper sheet P and a transport unit 2A including a plurality of rollers (a drive roller 4A and driven rollers 5A and 6A) on which the transport belt 3A is wound are provided on the downstream side of the gate roller 7. The transport belt 3A has a plurality of suction holes 3a, and the recording paper sheet P is suctioned by the suction holes 3a using a suction unit 8 as illustrated by arrows (broken lines) in FIG. 1A so as to be reliably transported in the transport direction.

A recording head 10 for ejecting ink is provided at a position opposing the transport surface of the transport belt 3A. The recording head 10 includes a plurality of heads 10a disposed in the widthwise direction of the paper sheet in zigzags, and each head 10a has ink nozzles (not shown) for colors such as yellow, magenta, cyan, and black that are installed in zigzags in the transport direction of the recording paper sheet P. Ink is supplied from ink tanks (not shown) for various colors to the ink nozzles (not shown) through ink supply tubes (not shown).

Fine ink dots are formed on the recording paper sheet P by ejecting a necessary amount of ink droplets from the ink ejection nozzles. A recording operation is completed by ejecting ink droplets for the colors and passing the recording paper sheet P adsorbed to the transport belt 3A only once.

A drying unit 12A is provided on the downstream side of the recording head 10. The drying unit 12A includes a blowing fan 14 and a heater 15 inside a main case 13a, and exterior air C is introduced into the unit through exterior air intake holes 20, is heated to become hot air (drying air), and is ejected toward the recording paper sheet P (whose recording operation is completed) using louvers (wing plates) 16 to promote drying of the ink.

A transport unit 2B opposes the drying unit 12A. The transport unit 2B includes a transport belt 3B and a plurality of rollers (a drive roller 4B and driven rollers 5B and 6B) to transport the recording paper sheet P, but has the same structure as the transport unit 2A for which reason a detailed description thereof will be omitted.

In the drying unit 12A, the angle of the louvers 16 is set such that hot air is ejected toward the downstream side (the right side in FIG. 2) of the paper sheet transport direction, whereby a main passage for the hot air flowing toward the downstream side of the paper sheet transport direction on a surface of the paper sheet as indicated by arrows (solid lines) a in FIG. 2 is formed.

Meanwhile, a sub-case 13b is connected to the main case 13a and blades 17 are installed perpendicular to the surface of the recording paper sheet P in the sub-case 13b whereby a sub-passage branched out from the main passage a and then merging with the main passage a is formed as indicated by the reference numeral b. A plurality of sub-cases 13b and a plurality of blades 17 are disposed along the paper sheet transport direction, whereby a serpentine passage that extends in a serpentine shape along the paper sheet transport direction is formed while branching out from the main passage a.

Since the drying unit 12A includes the sub-passage b that extends in a direction crossing a surface of the recording paper sheet P and merges with the main passage a in addition to the main passage a for hot air as a gas flowing along the paper sheet transport direction on the surface of the recording paper sheet P, the hot air can come into sufficient contact with the recording surface of the recording paper sheet P, thereby increasing the efficiency of heat transfer to the recording paper sheet P.

As a result, since ink can be sufficiently dried without hot air being flowed through long distance of paper sheet, the large size of the unit is thereby made unnecessary. In addition, since when the sub-passage b mergers with the main passage a, turbulent flows are formed, and drying of the ink can be promoted further by the turbulent flows.

In the embodiment of the invention, since the sub-passage b extends perpendicular to the main passage a and merges with the main passage a, the recording paper sheet P can be pressed to a remarkable degree, thereby preventing the lowering of recording quality that accompanies the floating of the recording paper sheet P. In particular, even if turbulent flows are formed when the sub-passage b merges with the main passage a, the floating of an end of the recording paper P caused by the turbulent flows can be prevented.

Further, since the sub-case 13b is formed of a high insulation material or an insulator is provided outside the sub-case 13b, heat is prevented from being emitted to the outside easily.

### Second Embodiment

Hereinafter, the second embodiment of the invention will be described with reference to FIG. 3. In the following embodiments including the second embodiment of the invention, the same elements as the first embodiment of the invention are endowed with the same reference numerals with reference to FIGS. 1 and 2 for which reason a detailed description thereof will be omitted.

The drying unit 12B according to the second embodiment of the invention includes auxiliary fans 22 above the blades 17. The flow rate of the sub-passage b is improved by the auxiliary fans 22 when the sub-passage b merges with the main passage a, increasing the efficiency of heat transfer to the recording paper P, whereby drying of the ink is promoted and a remarkable pressing effect (floating prevention effect) of the recording paper sheet P can be obtained.

### Third Embodiment

Hereinafter, the third embodiment of the invention will be described with reference to FIG. 4. The drying unit 12C according to the third embodiment of the invention includes a cover 19 above the sub-case 13b, and a serpentine space (serpentine passage) is formed between the sub-case 13b and the cover 19.

The serpentine passage is an exterior air intake passage into the main case 13a, and the exterior air (indicated by white arrows) introduced from the exterior air intake port 21 is heated to be the exterior air c′ by the heat transfer from the sub-case 13b and is guided into the main case 13a. Therefore, according to the embodiment of the invention, energy (of the heater 15) can be saved by efficiently using the heat of the sub-passage b.

The reference numeral 18 indicates auxiliary heaters and the drying efficiency of the ink can be additionally enhanced by raising the temperature of the sub-passage b or preventing the lowering of the temperature of the sub-passage b using the auxiliary heaters 18. The reference numeral 23 indicates an insulator provided outside the sub-case 13b to attempt to suppress the lowering the temperature of the sub-passage b.

### Fourth Embodiment

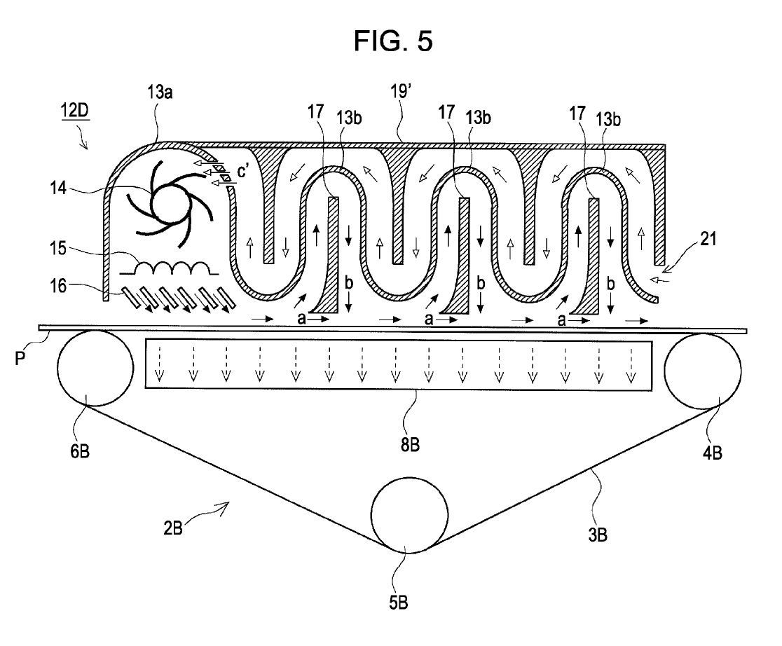

Hereinafter, the fourth embodiment of the invention will be described with reference to FIG. 5. The drying unit 12D according to the fourth embodiment of the invention includes a cover 19′ on the sub-case 13b and forms a serpentine space (serpentine passage) between the sub-case 13b and the cover 19′. Therefore, as in the third embodiment of the invention, energy (of the heater 15) can be saved by efficiently using the heat of the sub-passage b. Further, since the introduced exterior air is heated at a position near the heater 15, the introduced exterior air can be efficiently heated.

The above-described embodiments of the invention are merely some embodiments of the invention, and it is apparent that the scope of the invention is not limited to them. Further, the characteristic configuration of the embodiments of the invention may be properly combined. For example, in the third embodiment of the invention illustrated in FIG. 4, it is apparent that even when the auxiliary heaters 18 are not provided, the introduced air can be heated using the sub-case 19. Further, it is apparent that the auxiliary heaters 18 may be employed in the first embodiment of the invention illustrated in FIG. 2, the second embodiment of the invention illustrated in FIG. 3, or the fourth embodiment of the invention illustrated in FIG. 5 to achieve the same operation and effect.

What is claimed is:

1. A recording apparatus comprising:
a recording unit that performs a recording operation on a recording medium;
a transport unit that transports the recording medium; and
a drying unit that promotes drying of the recording medium by ejecting gas to the recording medium,
wherein the drying unit includes a main passage through which the gas flows on a surface of the recording medium along the transport direction of the recording medium, and a sub-passage that merges with the main passage and extends in a direction crossing the surface of the recording medium when merging with the main passage.

2. The recording apparatus according to claim 1, wherein the sub-passage extends perpendicular to the surface of the recording medium when merging with the main passage.

3. The recording apparatus according to claim 1, wherein the sub-passage is a serpentine passage that extends in a serpentine shape along the transport direction of the recording medium while branching out from the main passage and merges with the main passage at a plurality of points.

4. The recording apparatus according to claim 3, wherein the drying unit includes an exterior air intake passage that is formed using a case forming the serpentine passage, and the introduced exterior air is heated using the heat transferred from the case and is introduced into the drying unit.
